(19) United States
(12) Patent Application Publication
(10) Pub. No.: US 2014/0197906 A1
(43) Pub. Date: Jul. 17, 2014

(54) COMMON MODE FILTER

(71) Applicant: MAX ECHO TECHNOLOGY CORPORATION, Taichung City (TW)

(72) Inventors: Bin-Chyi Tseng, Chiayi City (TW); Koung-Fong Liu, Taichung City (TW); Yu-Cheng Lin, Taichung City (TW)

(73) Assignee: MAX ECHO TECHNOLOGY CORPORATION, Taichung City (TW)

(21) Appl. No.: 14/150,459

(22) Filed: Jan. 8, 2014

(30) Foreign Application Priority Data
Jan. 14, 2013 (TW) 102200792

(51) Int. Cl. H01P 1/20

(52) U.S. Cl. CPC H01P 1/20
USPC 333/202

(57) ABSTRACT

A common mode filter includes a plurality of substrates stacked along an axial direction, a first conductor structure and a second conductor structure disposed on the substrates and including a plurality of first rings and second rings disposed sequentially along the axial direction. The first rings and the second rings are disposed to alternate with each other along the axial direction. The first conductor structure and the second conductor structure are spaced apart by a first clearance in a first direction transverse to the axial direction.

### CROSS-REFERENCE TO RELATED APPLICATION

This application claims priority of Taiwanese application no. 102200792, filed on Jan. 14, 2013.

### BACKGROUND OF THE INVENTION

1. Field of the Invention

The present invention relates to a common mode filter.

2. Description of the Related Art

In recent years, as the amount of data transfer increases, differential signals are being used widely in high-speed data transmission. Although differential signals generally perform better in terms of resistance to noise and electromagnetic interference, common mode (common mode) noise will still be generated in the circuit paths due to the impacts of the actual circuit layout and its surrounding environment, causing transmission signal distortion and electromagnetic interference. Furthermore, the common-mode noise is the main source of electron radiation. Therefore, in order to comply with the electromagnetic compatibility (EMC) standard, the conversion between common mode and differential mode in the data signal suppressed, i.e., the problem of mode conversion, must be effectively

Referring FIGS. 1, 2 and 3, a conventional common mode filter includes a plurality of substrates 11 stacked along a Y-axis, a positive conductor structure 12 disposed on the substrates 11 and extending around the Y-axis, and a negative conductor structure 13 disposed on the substrates 11 and extending around the Y-axis. The negative conductor structure 13 and the positive conductor structure 12 cross each other with respect to the Y-axis.

The positive conductor structure 12 and the negative conductor structure 13 are arranged closely adjacent to each other on an X-axis that is perpendicular with the Y-axis and overlap each other on a Z-axis that is perpendicular with the Y-axis and the X-axis. Therefore, the symmetry and balance of the positive conductor structure 12 and the negative conductor structure 13 in the electromagnetic field is poor, resulting in poor suppression of mode conversion. Moreover, the overlapping areas of the positive conductor structure 12 and the negative conductor structure 13 generate parasitic capacitance, thereby degrading the electrical characteristics of the common mode filter.

### SUMMARY OF THE INVENTION

The object of the present invention is to provide a common mode filter that is capable of mitigating mode conversion problems in differential signals.

According to this invention, a common mode filter includes a plurality of substrates stacked along an axial direction, a first conductor structure disposed on the substrates and including a plurality of first rings connected electrically in series and disposed sequentially along the axial direction, and a second conductor structure disposed on the substrates and including a plurality of second rings connected electrically in series and disposed sequentially along the axial direction.

The first rings and the second rings are disposed to alternate with each other along the axial direction. The first conductor structure and the second conductor structure are spaced apart by a first clearance in a first direction transverse to the axial direction.

### BRIEF DESCRIPTION OF THE DRAWINGS

Other features and advantages of the present invention will become apparent in the following detailed description of the preferred embodiments with reference to the accompanying drawings, of which:

FIG. 1 is an exploded view of a conventional common mode filter;

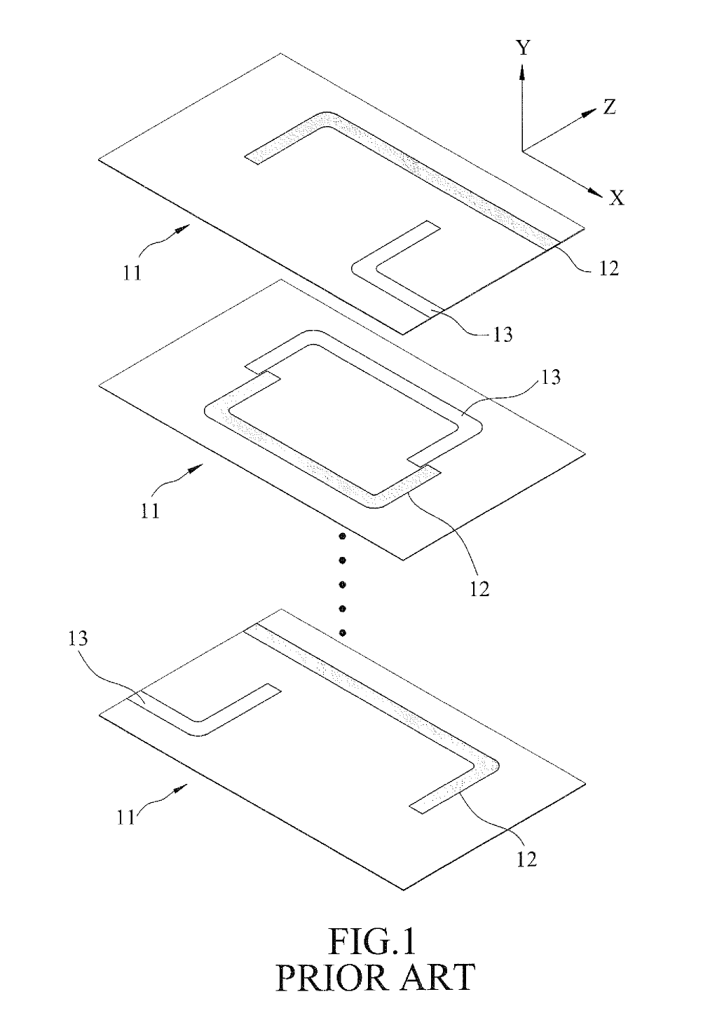

FIG. 2 is a perspective view showing a positive conductor structure and a negative conductor structure of the conventional common mode filter;

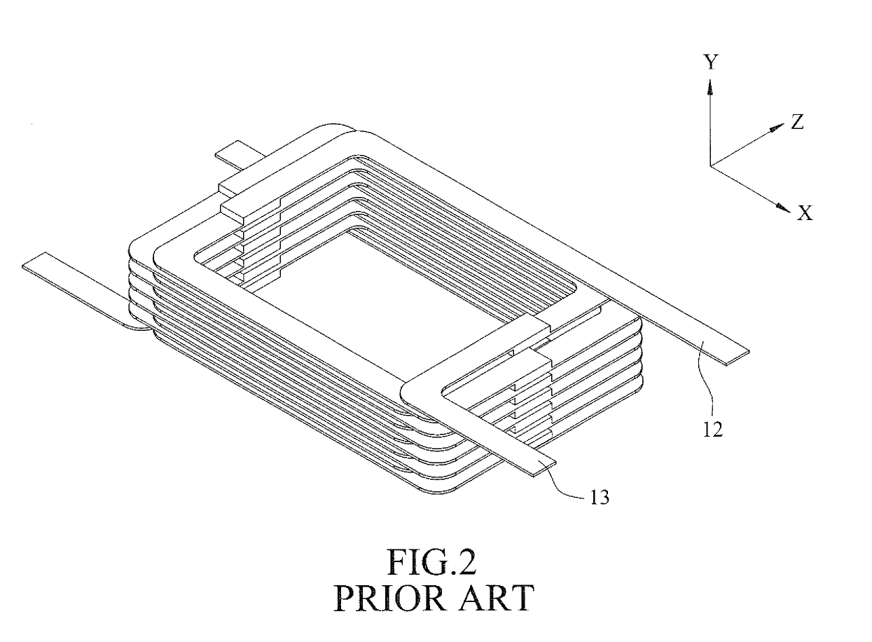

FIG. 3 is a top view of the positive conductor structure and the negative conductor structure of the conventional common mode filter;

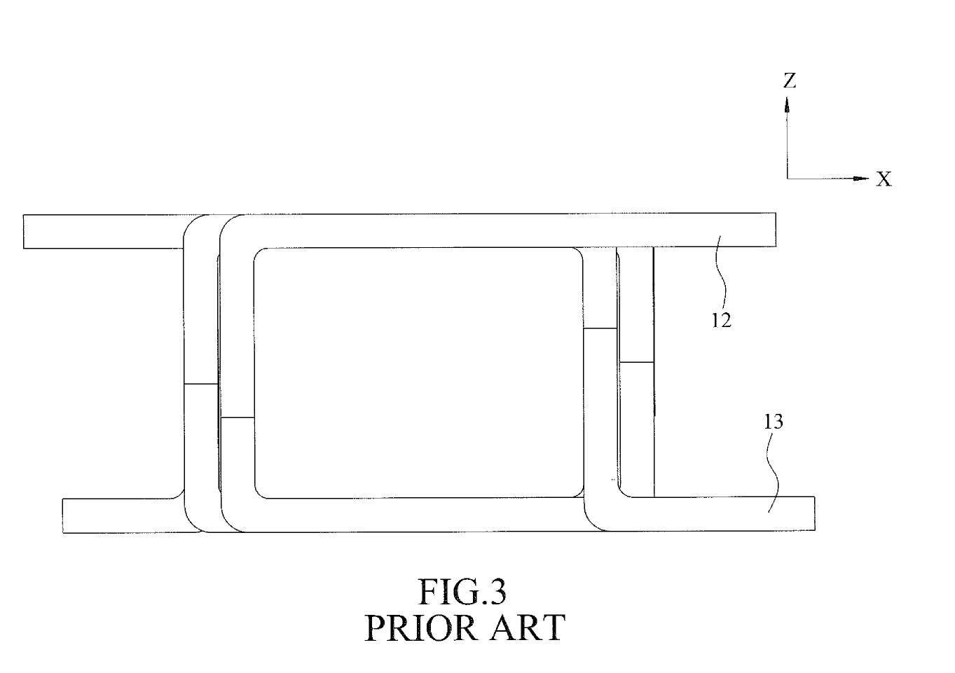

FIG. 4 is a perspective view of a first embodiment of a common mode filter according to the present invention;

FIG. 5 is an exploded view of the first embodiment of the present invention;

FIG. 6 is a top view showing a first ring and a second ring in the first embodiment of the present invention;

FIG. 7 is a frequency response diagram illustrating the mode conversion suppression effect in the first embodiment of the present invention;

FIG. 8 is a perspective view of a second embodiment of a common mode filter in the first embodiment of the present invention having a first conductor structure and a second conductor structure; and

FIG. 9 is a top view showing a first ring and a second ring of the common mode filter in the second embodiment of the present invention.

### DETAILED DESCRIPTION OF THE PREFERRED EMBODIMENTS

Before the present invention is described in greater detail with reference to the preferred embodiments, it should be noted herein that like elements are denoted by the same reference numerals in the following detailed description.

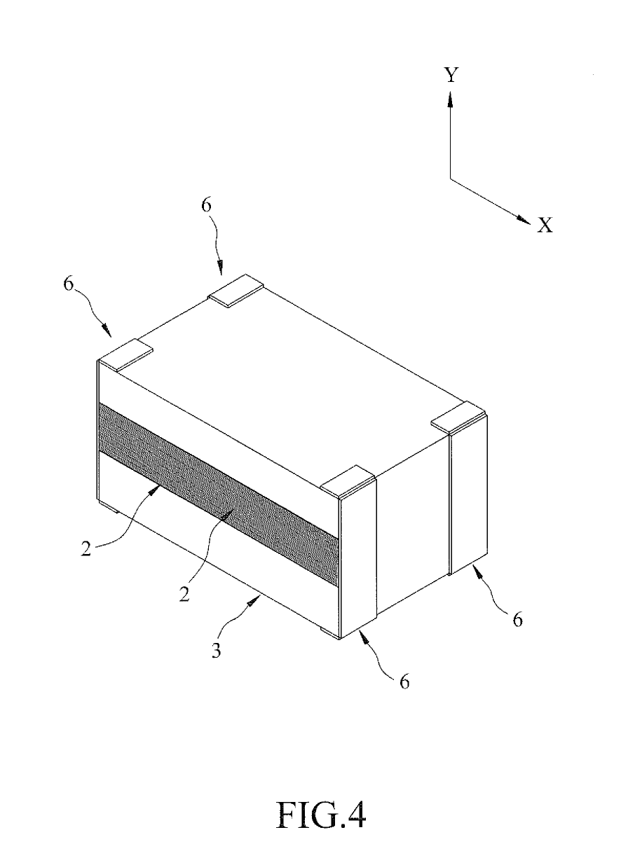

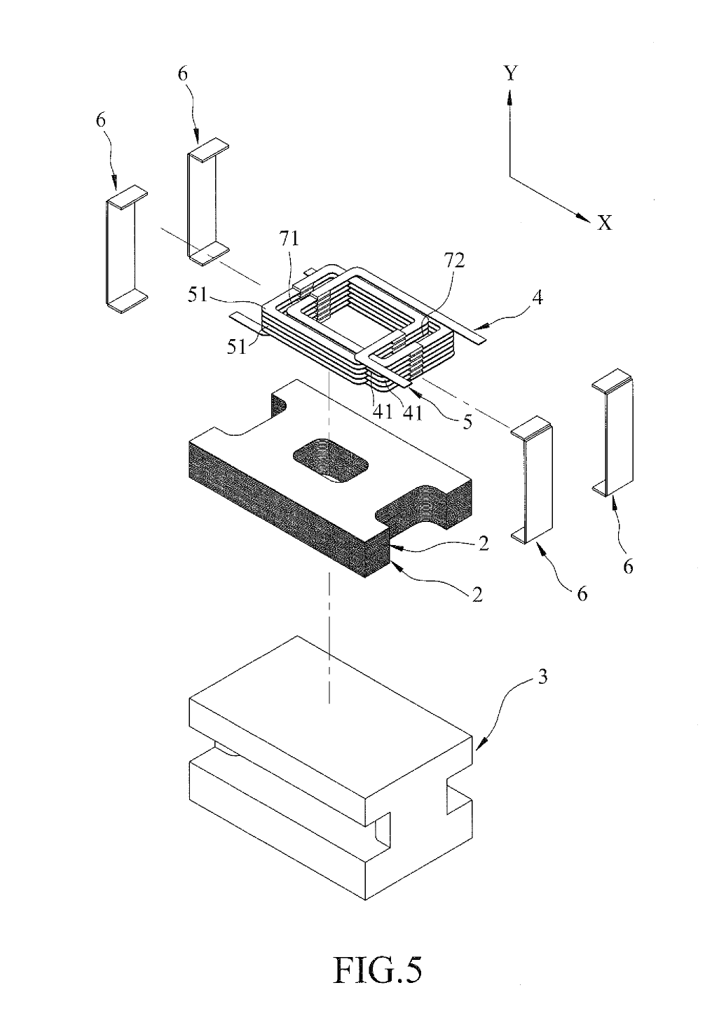

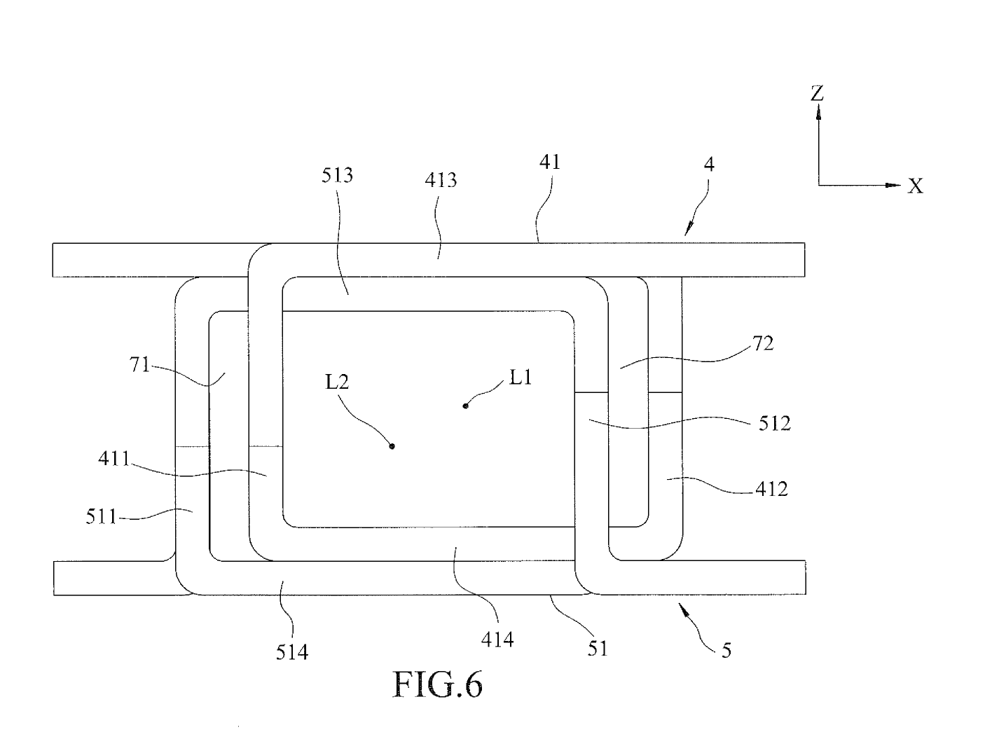

Referring to FIG. 4, FIG. 5 and FIG. 6, a common mode filter according to the present invention includes a plurality of substrates 2, a base 3, a first conductor structure 4, a second conductor structure 5, and a plurality of terminal electrodes 6.

The plurality of substrates 2 are stacked along an axial direction Y, and are disposed on the base 3.

The first conductor structure 4 is disposed on the substrates 2 and includes a plurality of first rings 41 connected electrically in series and disposed sequentially along the axial direction Y.

In this embodiment, each of the first rings 41 has a first ring section 411, a second ring section 412 disposed opposite to the first ring section 411, a first connecting section 413 connected between the first ring section 411 and the second ring section 412, and a second connecting section 414 disposed opposite to the first connecting section 413 and connected between the first ring section 411 and the second ring section 412.

The second conductor structure 5 is disposed on the substrates 2 and includes a plurality of second rings 51 connected electrically in series and disposed sequentially along the axial direction Y. The first rings 41 and the second rings 51 are disposed to alternate with each other along the axial direction Y.

In this embodiment, each of the second rings 51 has a first ring segment 511 disposed adjacent to the first ring sections 411 of the first rings 41, and a second ring segment 512 disposed opposite to the first ring segment 511. Each of the second rings 51 further has a first connecting segment 513 disposed adjacent to the first connecting sections 413 of the first rings 41 and connected between the first ring segment 511 and the second ring segment 512, and a second connecting segment 514 disposed opposite to the first connecting segment 513 and connected between the first ring segment 511 and the second ring segment 512.

In this embodiment, the first rings 41 and the second rings 51 are substantially similar in size and shape and are preferred to be substantially rectangular. However, the first rings 41 and the second rings 51 may have the shape of a square or other shapes in other embodiments of this invention.

Preferably, the first conductor structure 4 has a first axis L1, and the second conductor structure 5 has a second axis L2. The second axis L2 forms a first offset with the first axis L1 in a first direction X transverse to the axial direction Y, and further forms a second offset with the first axis L1 in a second direction Z transverse to the first direction X and the axial direction Y.

In this embodiment, the first offset is sufficient to space the first ring sections 411 of the first rings 41 apart from the first ring segments 511 of the second rings 51 by the first clearance 71 in the first direction X, and to space the second ring sections 412 of the first rings 41 apart from the second ring segments 512 of the second rings 51 by a second clearance 72 in the first direction X.

Moreover, the second offset is sufficient to configure projections of the first connecting sections 413 of the first rings 41 on a virtual plane perpendicular to the axial direction Y to be substantially free from overlap with projections of the first connecting segments 513 of the second rings 51 on the virtual plane, and to configure projections of the second connecting sections 414 of the first rings 41 on the virtual plane to be substantially free from overlap with projections of the second connecting segments 514 of the second rings 51 on the virtual plane.

In this embodiment, each of the first ring sections 411, the second ring sections 412, the first ring segments 511 and the second ring segments 512 extends in the second direction Z, and each of the first connecting sections 413, the second connecting sections 414, the first connecting segments 513 and the second connecting segments 514 extends in the first direction X. Moreover, the first ring sections 411 and the second ring segments 512 are disposed between the first ring segments 511 and the second ring sections 412 in the first direction X, and the second connecting sections 414 and the first connecting segments 513 are disposed between the first connecting sections 413 and the second connecting segments 514 in the second direction Z.

The terminal electrodes 6 are provided on the base 3, and are electrically connected with the first conductor structure 4 and the second conductor structure 5, respectively.

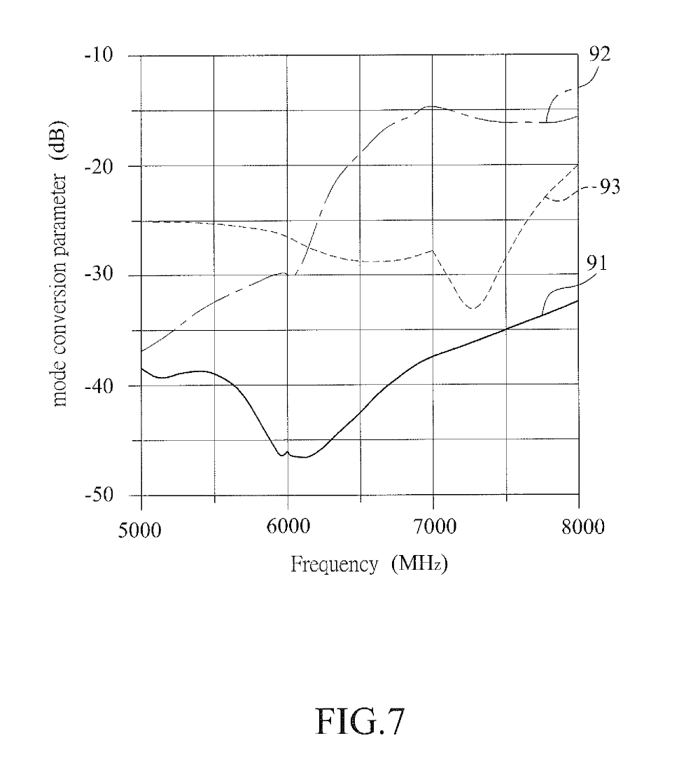

Referring to FIG. 7, the curve 91 represents the parameters of mode conversion in the first preferred embodiment, and the curve 92 represents the parameters of mode conversion in the prior art. In the 5 GHz˜8 GHz frequency band, the curve 91 is below the curve 92, i.e., the mode conversion suppression effect in the first preferred embodiment is better than that in the prior art. In this band, mode conversion parameters of the curve 91 are substantially lower than −20 dB, which means that the present embodiment has a superior structural symmetry that does not produce additional noise.

The advantages of the present invention can be summarized as follows:

The new layout is designed such that the first ring sections 411 of the first rings 41 are spaced apart from the first ring segments 511 of the second rings 51 by a first clearance 71 in a first direction X transverse to the axial direction Y, and the second ring sections 412 of the first rings 41 are spaced apart from the second ring segments 512 of the second rings 51 by a second clearance 72 in the first direction X.

Therefore, by virtue of the clearances 71, 72 in the first direction X, the symmetry and balance of the first conductor structure 4 and the second conductor structure 5 in the electromagnetic field is improved, resulting in improvements in the suppression of mode conversion problems in differential signals.

Furthermore, since the projections of the first connecting sections 413 of the first rings 41 on a virtual plane perpendicular to the axial direction Y are substantially free from overlap with projections of the first connecting segments 513 of the second rings 51 on the virtual plane, and since the projections of the second connecting sections 414 of the first rings 41 on the virtual plane are substantially free from overlap with projections of the second connecting segments 514 of the second rings 51 on the virtual plane, the parasitic capacitance problem encountered in the prior art and attributed to overlapping conductor parts can be mitigated, thus improving the electrical characteristics of the common mode filter of the first preferred embodiment.

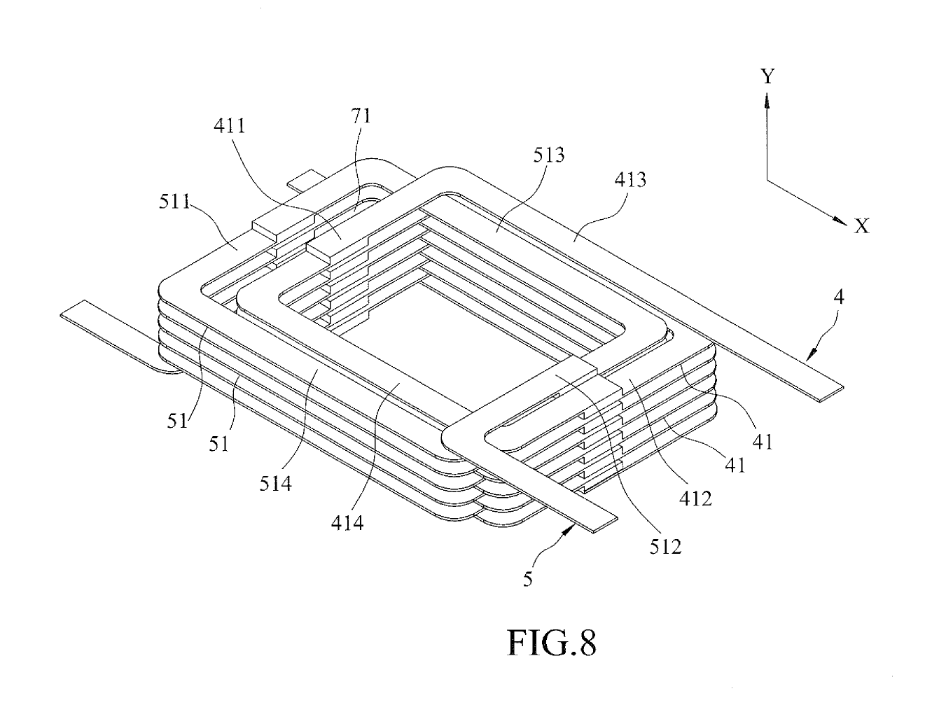

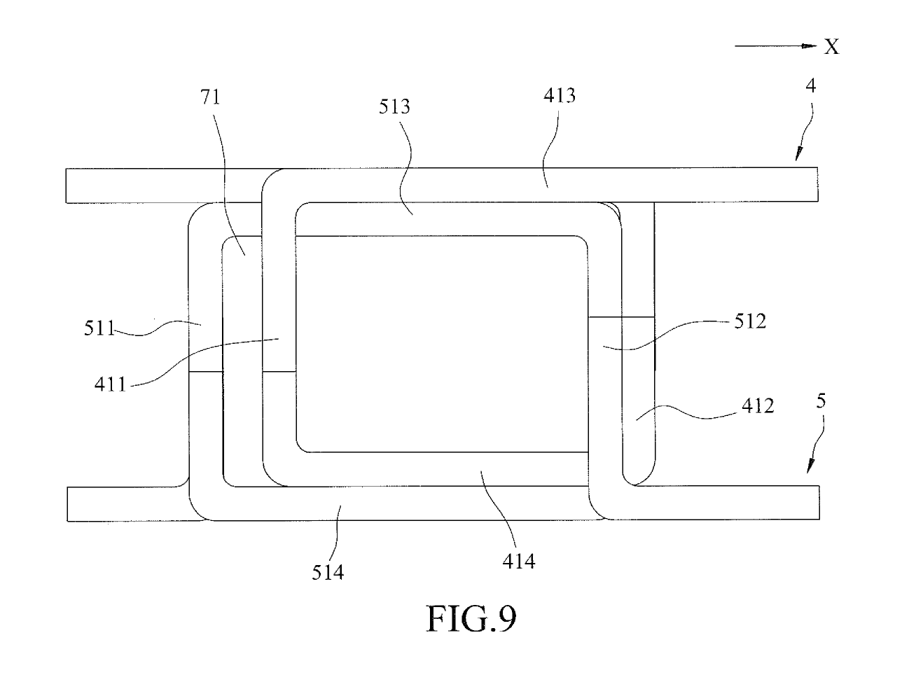

FIGS. 8 and 9 disclose a second preferred embodiment of the present invention, which is similar to the first preferred embodiment. The differences between the second preferred embodiment and the first preferred embodiment reside in the following.

In the second preferred embodiment, the first rings 41 and the second rings 51 have different sizes, the first ring sections 411 of the first rings 41 are spaced apart from the first ring segments 511 of the second rings 51 by a first clearance 71 in the first direction X transverse to the axial direction Y, and the second ring sections 412 of the first rings 41 do not form a second clearance in the first direction X with the second ring segments 512 of the second rings 51.

Referring once again to FIG. 7, the curve 93 represents the parameters of mode conversion in the second preferred embodiment, and the curve 92 represents the parameters of mode conversion in the prior art. In the frequency band higher than 6 GHz, the curve 93 is below the curve 92, i.e., the mode conversion suppression effect in the second preferred embodiment is better than that in the prior art. In the frequency band that is higher than 6 GHz, mode conversion parameters of the curve 93 are substantially lower than −20 dB, which means that the present embodiment has a superior structural symmetry that does not produce additional noise. Therefore, the second preferred embodiment is able to exhibit effects similar to those of the first preferred embodiment.

In summary, not only are the symmetry and balance of the first conductor structure 4 and the second conductor structure 5 in the electromagnetic field improved, suppression of mode conversion problems in differential signals are improved as well.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A common mode filter, comprising:
a plurality of substrates stacked along an axial direction;
a first conductor structure disposed on said substrates and including a plurality of first rings connected electrically in series and disposed sequentially along the axial direction; and
a second conductor structure disposed on said substrates and including a plurality of second rings connected electrically in series and disposed sequentially along the axial direction;
wherein said first rings and said second rings are disposed to alternate with each other along the axial direction; and
wherein said first conductor structure and said second conductor structure are spaced apart by a first clearance in a first direction transverse to the axial direction.

2. The common mode filter as claimed in claim 1, wherein:
each of said first rings has a first ring section, and a second ring section disposed opposite to said first ring section;
each of said second rings has a first ring segment disposed adjacent to said first rings sections of said first rings, and a second ring segment disposed opposite to said first ring segment; and
said first ring sections of said first rings are spaced apart from said first ring segments of said second rings by the first clearance in the first direction.

3. The common mode filter as claimed in claim 2, wherein said second ring sections of said first rings are spaced apart from said second ring segments of said second rings by a second clearance in the first direction.

4. The common mode filter as claimed in claim 2, wherein:
each of said first rings further has a first connecting section connected between said first ring section and said second ring section, and a second connecting section disposed opposite to said first connecting section and connected between said first ring section and said second ring section; and
each of said second rings further has a first connecting segment disposed adjacent to said first connecting sections of said first rings and connected between said first ring segment and said second ring segment, and a second connecting segment disposed opposite to said first connecting segment and connected between said first ring segment and said second ring segment.

5. The common mode filter as claimed in claim 4, wherein:
projections of said first connecting sections of said first rings on a virtual plane perpendicular to the axial direction are substantially free from overlap with projections of said first connecting segments of said second rings on the virtual plane; and
projections of said second connecting sections of said first rings on the virtual plane are substantially free from overlap with projections of said second connecting segments of said second rings on the virtual plane.

6. The common mode filter as claimed in claim 5, wherein said second ring sections of said first rings are spaced apart from said second ring segments of said second rings by a second clearance in the first direction.

7. The common mode filter as claimed in claim 1, wherein said first rings and said second rings are substantially rectangular in shape.

8. The common mode filter as claimed in claim 4, wherein said first conductor structure has a first axis, and said second conductor structure has a second axis, the second axis forming a first offset with the first axis in the first direction and further forming a second offset with the first axis in a second direction transverse to the first direction and the axial direction.

9. The common mode filter as claimed in claim 8, wherein:
the first offset is sufficient to space said first ring sections of said first rings apart from said first ring segments of said second rings by the first clearance in the first direction; and
the second offset is sufficient to configure projections of said first connecting sections of said first rings on a virtual plane perpendicular to the axial direction to be substantially free from overlap with projections of said first connecting segments of said second rings on the virtual plane, and to configure projections of said second connecting sections of said first rings on the virtual plane to be substantially free from overlap with projections of said second connecting segments of said second rings on the virtual plane.

10. The common mode filter as claimed in claim 9, wherein each of said first ring sections, said second ring sections, said first ring segments and said second ring segments extends in the second direction, and each of said first connecting sections, said second connecting sections, said first connecting segments and said second connecting segments extends in the first direction.

11. The common mode filter as claimed in claim 10, wherein said first ring sections and said second ring segments are disposed between said first ring segments and said second ring sections in the first direction, and said second connecting sections and said first connecting segments are disposed between said first connecting sections and said second connecting segments in the second direction.
